(19) United States
(12) Patent Application Publication
(10) Pub. No.: US 2014/0280624 A1
(43) Pub. Date: Sep. 18, 2014

(54) SYSTEM AND METHOD FOR PROVIDING ACTIONABLE RECOMENDATIONS TO IMPROVE ELECTRONIC MAIL INBOX PLACEMENT AND ENGAGEMENT

(71) Applicant: RETURN PATH, INC., New York, NY (US)

(72) Inventors: Jeremy K. DILLINGHAM, Lafayette, CO (US); George M. BILBREY, Lafayette, CO (US); Robert B. BARCLAY, Thornton, CO (US)

(21) Appl. No.: 13/835,872

(22) Filed: Mar. 15, 2013

(51) Int. Cl. H04L 12/58

(52) U.S. Cl. CPC H04L 51/22
USPC 709/206

(57) ABSTRACT

A system and method for analyzing data obtained from distinct sources to provide email senders with specific actionable recommendations that can be used to improve the inbox placement of the email messages they send, as well as recipients' level of engagement with those email messages.

### BACKGROUND OF THE INVENTION

1. Field of the Invention

The present invention relates to a system and method for improving the inbox placement of email messages for a list of intended recipients. In particular, the invention relates to a system and method for analyzing data obtained from distinct sources to provide email senders with specific actionable recommendations that can be used to improve the inbox placement of the email messages they send, as well as improve recipients' engagement with those email messages.

2. Description of the Related Art

Email campaigns are widely used by established companies with legitimate purposes and responsible email practices to advertise, market, promote, or provide existing customers with information related to one or more products, services, events, etc. Such email campaigns may be used for commercial or non-commercial purposes. They can be targeted to a specific set of recipients, and to a particular goal, such as increasing sales volume or increasing donations.

It is a desire of email campaign managers, and others who initiate email campaigns, for sent messages to be ultimately delivered to the intended message recipients. For instance, campaign managers aspire to maximize inbox placement (i.e., the percentage of sent messages that are delivered to the email inboxes of intended recipients), while minimizing the percentage of sent messages that are delivered to spam or junk mail folders or are discarded by an intended recipient's internet service provider (ISP). U.S. patent application Ser. No. 13/449,153, which is incorporated herein by reference in its entirety, describes a system and method for monitoring the inbox placement of email messages.

It is a further desire of email campaign managers, and others who initiate email campaigns, to maximize message recipients' level of engagement with their email campaigns. For instance, campaign managers aspire to maximize the percentages of messages that intended recipients read, forward, or mark as not spam, while minimizing the percentage of messages that intended recipients mark as spam, or delete without reading. U.S. patent application Ser. No. 13/538,518, which is incorporated herein by reference in its entirety, describes a system and method for monitoring recipients' level of engagement with email messages.

In addition to monitoring inbox placement, there exists a need for a system and method that provides campaign managers with actionable recommendations that may be implemented in order to improve the inbox placement of email messages.

Furthermore, in addition to monitoring recipients' level of engagement with email messages, there exists a need for a system and method that provides campaign managers with actionable recommendations that may be implemented in order to improve the recipients' level of engagement with email messages.

### SUMMARY OF THE INVENTION

Accordingly, it is an object of the invention to provide a system and method for providing specific actionable recommendations that can be implemented by email senders to improve the inbox placement of sent messages.

It is another object of the invention to provide a system and method for providing specific actionable recommendations that can be implemented by email senders to improve recipients' level of engagement with email messages.

Those and other objects of the invention are accomplished, as fully described herein, by a method comprising the steps of: receiving message related data from one or more data sources; analyzing one or more values associated with the message; and generating an actionable recommendation for improving inbox placement and/or engagement based on the one or more values.

Those and other objects of the invention are also accomplished, as fully described herein, by a system comprising: a seed database for storing data related to one or more seed email accounts; a subscriber database for storing data related to one or more subscriber email accounts; a data feed database for storing data received from one or more trusted networks; and an email analysis application configured to generate recommendations for improving message inbox placement & engagement.

Specific actionable recommendation provided by the system and method may be based entirely on a single value associated with the message. In addition, specific actionable recommendations may be based on a combination of, or interrelation between, two or more values associated with the message

With those and other objects, advantages, and features of the invention that may become hereinafter apparent, the nature of the invention may be more clearly understood by reference to the following detailed description of the invention, the appended claims, and the several drawings attached herein.

### BRIEF DESCRIPTION OF THE DRAWINGS

FIG. 1 is a flowchart of an exemplary method for providing actionable recommendations for improving email message inbox placement in accordance with an exemplary embodiment of the invention;

FIG. 2 is a diagram of an exemplary system for providing actionable recommendations for improving email message inbox placement and engagement in accordance with an exemplary embodiment of the invention;

FIG. 3 is a diagram illustrating the flow of data in accordance with an exemplary embodiment of the present invention;

FIGS. 4A and 4B are a table that includes exemplary variables that may be used by the analytics model to provide actionable recommendations in accordance with an exemplary embodiment of the invention

FIG. 5 is a graphic display of a user interface in accordance with an exemplary embodiment of the invention; and

FIG. 6 is a graphic display of a user interface in accordance with an exemplary embodiment of the invention.

### DETAILED DESCRIPTION OF THE PREFERRED EMBODIMENTS

Several preferred embodiments of the invention are described for illustrative purposes, it being understood that the invention may be embodied in other forms not specifically shown in the drawings. The present invention includes a system and method for providing specific actionable recommendations to email campaign managers, and others who initiate email campaigns, that can be implemented to improve the inbox placement of email messages, and recipients' level of engagement with email messages. In particular, the invention advises email senders as to exactly what changes can be made to an email campaign in order to increase the likelihood that messages associated with the campaign will be delivered to the inboxes of intended recipients, as opposed to being delivered to folders, such as spam or junk mail folders, or not being delivered at all. The invention also advises email senders as to exactly what changes can be made to an email campaign in order to improve recipients' engagement with campaign messages. Such improvements include increasing the percentages of emails that are placed in the Inbox, read, forwarded, replied to, marked as priority, and/or marked as not spam, while decreasing the percentages of messages that are placed in the spam folder, deleted without being read and/or marked as spam. The invention is capable of using data from multiple distinct sources to automatically provide recommendations for improving message inbox placement and engagement.

The invention may provide recommendations at two levels. The first is the sender, or entity level. Recommendations provided at the first level pertain to inbox placement and engagement issues associated with a particular sender, i.e., issues that are common across all email campaigns initiated by that sender. An example of one such issue is a sender having a bad reputation with a particular ISP. Recommendations provided at the first level generally include program level changes that can be made in order to improve the overall inbox placement and engagement for messages from a sender. The second level is the specific message level. Recommendations provided at the second level pertain to inbox placement and engagement issues associated with specific email messages or campaigns. Such issues may relate to the content of a specific email message, including elements present in the subject line or body of the message. Recommendations provided at the second level generally include specific content level changes that can be made in order to improve the inbox placement and engagement for one or more specific email messages.

In order to provide actionable recommendations for improving the inbox placement and engagement of email messages, data is received from one or more distinct sources and analyzed to identify specific attributes of sent messages that may affect message inbox placement and engagement. Data that is analyzed by the invention can be classified based on the source from which the data is received. Classifications of data analyzed by the invention include seed data, subscriber data, and feed data received from one or more trusted cooperative networks.

Seed data includes information indicating a number of email messages associated with an email campaign that were delivered to a folder or folders associated with one or more intended recipients of the email campaign based on a sampling of seed accounts, wherein the seed accounts are not associated with actual recipients of the email campaign. It is appreciated that seed email accounts and seed data are used exclusively by the system to collect and tabulate statistics for monitoring email inbox placement and are not used to send any outbound email. Seed accounts do not correspond with real users, but instead are “dummy” accounts created by the system for monitoring of inbox placement data for an email campaign. Thus, “seeding” includes using an active email monitoring program to track and report email inbox placement at the receiving ISPs. This monitoring provides the sender (e.g., a marketer or anyone deploying an email campaign) with inbox placement metrics, such as whether email associated with a monitored campaign was delivered to a user's inbox, the user's spam folder, or was discarded by the ISP without being delivered to any user folder.

For the process of seeding in accordance with the present invention, a plurality of email accounts (e.g., 10-20) may be created at each of one or more ISPs/domains. In a preferred exemplary embodiment, seed accounts are established at each of the leading ISPs, which may include over 150 domains worldwide. Senders are then provided with the email addresses of the seed email accounts at each of the domains so that the sender may insert (or “seed”) the email addresses into their outbound email campaigns. The inbox placement rate of the email campaign may then be monitored using these seed accounts. As used herein, the inbox placement rate is a way to quantify the predicted percentage of emails delivered to the inbox. Senders may also login to monitor their practices using the system, which may generate and provide a report summary or detailed inbox placement metrics on a per-campaign basis and/or a per-ISP basis over a predetermined period of time.

In addition to monitoring the inbox placement of email messages sent to seed accounts, the present invention provides for the monitoring of various components of those messages. For example, the invention may include a program that monitors attributes of the sender (e.g., domain, IP address, etc.), as well as attributes of the message (e.g., types of content, use of words, URLs, etc.), authentication pass/fail, infrastructure checks, etc. All monitored information may be stored and analyzed in accordance with the invention.

Subscriber data includes data associated with actual customer email accounts (e.g., a subset of the email sender's real customers), including information indicating a number of email messages associated with the email campaign that are delivered to a folder or folders associated with the one or more intended recipients of the email campaign based on one or more subscriber accounts, wherein the subscriber accounts are associated with a subset of actual recipients of the email campaign. It is appreciated that subscriber data is not limited to folder placement data but also includes engagement data, which relates to recipient interaction with a message following its delivery. For example, engagement data may include whether the message is read, forwarded, replied to, marked as a high priority message, marked as not spam, trusted (e.g., associated with a trust mark), deleted without being read, or marked as spam. Subscriber data may be gathered from a group or panel of users who have opted-in to share this data. For example, subscriber data may be obtained from users who have agreed to terms of service agreements that allow the system to pull message related data from the user's email client program. It is appreciated that subscriber data may be provided anonymously and without any personally identifying information. Thus, the system can analyze subscriber data for a subset of real customers in order to provide message related metrics based on how email was delivered to, and interacted with by, actual recipients of the campaign rather than based on the seed accounts.

Feed data received from a trusted network includes data provided by ISPs, email service providers, hosting companies, feedback loops, spam trap networks, security companies, and other companies that receive large volumes of email. Feed data may be utilized by the invention, for example, to generate a sender score. Feed data can also be used to determine other values at both the sender and message levels. For example, feed data can be used to determine the actual complaint rate (i.e., the percentage of messages marked as spam by recipients), the bounce rate (i.e., the percentage of messages that are not delivered to any folder), etc. seen by the network for all email sent by a particular sender IP address or sender domain.

FIG. 1 is a flowchart of an exemplary method for providing actionable recommendations for improving email message deliverability in accordance with an embodiment of the invention. Referring to FIG. 1, at step 102, message related data is received from one or more data sources. The data sources may include a seed database 257, a subscriber database 259, and a data feed database 258 as illustrated in FIG. 2. At step 104, one or more values associated with the message are analyzed by the system. The analysis may include comparing the one or more values to corresponding ideal values or ideal ranges, as well as making determinations based on the combination of, or interrelation between, two or more values. At step 106, the system generates an actionable recommendation for improving inbox placement and/or engagement for the message based on the analysis. The method is described in greater detail below in view of the drawings provided herein.

FIG. 2 is a diagram of an exemplary system for providing actionable recommendations for improving email message inbox placement and engagement in accordance with an embodiment of the invention. Referring to FIG. 2, a sender at computer system 212 may compose an email message to send to multiple recipients, including users of computer systems 221, 222, and 233. When the sender at computer system 212 completes the email message and sends it, the email message is transported to mail server 215.

Mail server 215 parses the header information on the email message to determine where to send the email message. The body of an email message includes the content of the message targeted to the recipient of the email. The headers of an email message are targeted to the applications handling the delivery of the email. After parsing the email headers, email server 215 delivers the email message to email servers used by the users of computer systems 221, 222, and 233. In this example, mail server 215 sends the email message to mail server 225 and mail server 235.

Users of computer systems 221, 222, and 233 can access the email messages by accessing their local mail server. Local email client programs on computer systems 221, 222, and 233 may create local copies of the email message. Alternatively, the users of computer systems 221, 222, and 233 may use a web server-based email system that allows a user to access email on a mail server using a standard web browser on the local computer system.

FIG. 2 also illustrates a diagrammatic representation of a computer system (email analysis server) 250 within which a set of instructions may be executed for causing the machine to perform any one or more of the methodologies discussed herein. In alternative embodiments, the computer may operate as a standalone device or may be connected (e.g., networked) to other machines. In a networked deployment, the computer may operate in the capacity of a server or a client machine in server-client network environment, or as a peer machine in a peer-to-peer (or distributed) network environment. The computer may be a personal computer (PC), a tablet PC, a set-top box (STB), a Personal Digital Assistant (PDA), a cellular telephone, a web appliance, a network server, a network router, a network switch, a network bridge, or any computer capable of executing a set of instructions (sequential or otherwise) that specify actions to be taken by that computer. Further, while only a single computer (e.g., email analysis server 250) is illustrated in FIG. 2, the terms “computer” or “server” shall also be taken to include any collection of computers that individually or jointly execute a set (or multiple sets) of instructions to perform any one or more of the methodologies discussed herein.

The computer system 250 illustrated in FIG. 2 includes a processor (e.g., a central processing unit (CPU), a graphics processing unit (GPU) or both), one or more storage devices (e.g., a main memory and a static memory) such as databases 257-259, which communicate with each other via a bus. The computer system 250 may further include a video display adapter that drives a video display system such as a Liquid Crystal Display (LCD) or a Cathode Ray Tube (CRT). The computer system 250 may also include an alphanumeric input device (e.g., a keyboard), a cursor control device (e.g., a mouse or trackball), a disk drive unit, a signal generation device (e.g., a speaker), and a network interface device.

The subscriber database 259, the data feed database 258, the seed database 257, and the email analysis application 255 may include computer-readable media on which is stored one or more sets of computer instructions and data structures (e.g., software) embodying or utilized by any one or more of the methodologies or functions described herein. The computer-executable instructions may also reside, completely or at least partially, within the main memory and/or within the processor during execution thereof by the computer system 250.

The term “computer-readable medium” is understood to include a single medium or multiple media (e.g., a centralized or distributed database, and/or associated caches and servers) that store the one or more sets of instructions. The term “computer-readable medium” shall also be understood to include any tangible medium that is capable of storing, encoding, or carrying a set of non-transitory instructions for execution by the computer and that cause the computer to perform any one or more of the methodologies described herein, or that is capable of storing, encoding, or carrying data structures utilized by or associated with such a set of instructions. The term “computer-readable medium” shall accordingly be taken to include, but not be limited to, solid-state memories and optical and/or magnetic media.

The email analysis server 250 includes an email analysis application 255, a seed database 257, a data feed database 258, and a subscriber database 259. The seed database 257 is configured for receiving and storing seed data that includes information indicating a number of email messages associated with an email campaign that are delivered to a folder associated with one or more intended recipients of the email campaign based on a sampling of seed accounts, wherein the seed accounts are not associated with actual recipients of the email campaign. The seed data may further include message level data such as headers, content, URIs, sender IP address, sender domain, etc., of the messages sent to the seed accounts.

The data feed database 258 includes inbox placement and other data received directly from Internet service providers, email service provider, hosting providers, security companies, or other companies that receive large volumes of email.

The subscriber database 259 is configured for receiving and storing subscriber data that includes information indicating a number of email messages associated with the email campaign that are delivered to a folder associated with the one or more intended recipients of the email campaign based on one or more subscriber accounts, wherein the subscribers are actual recipients of the email campaign. The subscriber data may further include message level data such as headers, content, URIs, sender IP address, sender domain, etc. In addition, the subscriber data may include information indicating recipient interaction with email messages associated with the email campaign.

Moreover, the subscriber data may include an indication of how engaged recipients are with email in general, thereby providing a “quality of the list” of the subscribers from which data is gathered. Those recipients' general level of engagement with email can then be compared to their level of engagement with a particular campaign or sender, which results in the ability of the present invention to provide users with a greater context in which to understand engagement data as it relates to a particular campaign or sender. The results of the comparison may be provided to a user in the form of a value or other metric which may be presented, for example, via a display.

It is appreciated that the seed accounts and/or the subscriber accounts may be associated with a plurality of different email service providers (ESPs). In one embodiment, the subscriber database 259 is configured to receive subscriber data from a plug-in configured to communicate with an email program of the recipient.

In exemplary embodiments, the present invention may be capable of differentiating between various message types, such as transactional email messages (e.g., messages sent from an e-commerce company regarding recipients' specific purchases, transactions, etc.) and marketing email messages (e.g., messages sent to a large list of recipients for promotional purposes). Depending on a particular sender's interests, exemplary embodiments of the invention may be configured to analyze only marketing email message data, only transactional email message data, or both, which may provide a more accurate indication of the level of recipient interaction that is of interest to that sender.

The present invention may be capable of determining the number of email campaigns sent by one sender versus the number of email campaigns sent by another sender during a given time period. The present invention may also be capable of determining and providing information related to the number of recipients on a list that receive an email message, and provide an indication of whether the frequency with which certain recipients receive email messages is changing over time.

The present invention may also be capable of determining the extent to which a sender implements “segmentation.” For example, a typical sophisticated marketing campaign will not be sent to a sender's entire email list. Instead, the list will be divided into segments to allow the sending of more targeted email messages. For example, a company, such as an online retailer, may have equal numbers of male and female clientele. That company may send an email campaign advertising menswear only to male subscribers, and may send a different email campaign advertising womenswear only to female subscribers. A less sophisticated online retailer might send both types of email campaigns to its entire email list, which could lead to lower engagement and higher spam folder placement because male users might be less interested in women's clothing, and vice versa. An exemplary embodiment of the present invention may be capable of detecting when a sender is not using segmentation, and may provide the sender with a recommendation to implement segmentation, if the invention determines that such implementation might improve inbox placement or engagement. For senders that do implement segmentation, the present invention may detect levels of inbox placement and engagement for specific segments, and may recommend, for example, decreasing the frequency at which email messages are sent to a less engaged segment and/or increasing the frequency at which email messages are sent to a more engaged segment.

The email analysis application 255 is configured for determining one or more metrics based on the seed data and the subscriber data. In one embodiment, the email analysis application 255 is configured to match subscriber campaigns associated with campaign senders by parsing a matching ID included in an email header. For example, the matching ID includes an X-header value and the matching ID uniquely represents a campaign. The email analysis application 255 may match a subscriber campaign to a seeded campaign by determining a list of matching IDs associated with the seeded campaign and matching the matching IDs with the subscriber campaign. It is appreciated that the email analysis application 255 is configured to perform the matching in real-time or near real-time. The email analysis application 255 may also be configured to display the inbox placement and/or engagement metrics.

In another embodiment, the email analysis application 255 may be configured to determine the one or more metrics based on one of the subscriber data exclusively or the seed data exclusively, for an ISP, in the event that the number of mailboxes from which folder placement data is received is greater than or less than a predetermined threshold value. Furthermore, the email analysis application 255 may be configured to receive data associated with the email campaign directly from one of an internet service provider (ISP) and an email service provider (ESP). For example, the system may receive a feed from ISPs such as Yahoo! and Comcast that includes actual inbox placement data by IP address. It is appreciated that this data feed could be modified to include campaigns or X-headers, which could be used in addition to the seed and subscriber data without departing from the scope of the subject matter described herein. The email analysis application 255 may also be configured to receive data associated with a particular sender, such as the frequency with which the sender sends messages (i.e., the number of messages sent during a particular time period), or the duration between sent messages, using one or more particular IP addresses or sending domains. Such sender data may be stored and retrieved from the seed database 257, the data feed database 258, and/or the subscriber database 259, as appropriate in accordance with the present invention.

Turning to FIG. 3, shown therein is a diagram illustrating the flow of data in accordance with an exemplary embodiment of the present invention. At block 301, an email campaign is generated by a sender (e.g., campaign manager). At least one email message associated with the campaign is sent to each email address on a list of seed accounts (block 310), as well as to each address on a list of subscribers (block 320).

At block 311, for each message received by a seed account in accordance with the present invention, the message may be downloaded and stored. Inbox placement information, as well as whether the ISP placed the message in a spam folder of the seed account for example, is obtained along with information that allows the analysis model to identify the specific campaign with which the message is associated. It should be noted that inbox placement information, as well as other data, may be directly stored in the seed database 257. At block 312, a message daemon processes the message to specifically extract additional values of variables to be included in the subsequent analysis. At block 313, the message, along with identifying information, inbox placement data, and data provided by the message daemon, is stored in the seed database 257.

Referring back to block 320, an email message is sent to each address on a list of subscribers. Of all the emails that are sent to subscribers, some of those emails are delivered to panel mailboxes (block 321), where the panel consists of a subset of subscribers who have authorized the sharing of data related to their engagement with received messages. At block 322, each message is processed to obtain inbox placement data, engagement data, campaign identifying information, and other information related to message attributes. Data corresponding to messages associated with a particular campaign may be aggregated, as described in U.S. patent application Ser. No. 13/538,518 for example, to obtain overall engagement statistics for the campaign. In addition, personal identifying information may be removed from each message to maintain the anonymity of panel members. At block 323, the message, along with identifying information, inbox placement data, engagement data, and other information related to message attributes, is stored in the subscriber deliverability database 259.

The system also receives data from ISPs (block 331), hosting companies (block 332), feedback loops (block 333), and security vendors (block 334). Data received from each of those data feeds is stored in the data feed database 258 (block 335).

Data received from data feeds can be classified into several types including, for example, volume data received from ISPs (331) and hosting companies (332), message level data received from feedback loops (333), authentication data received from ISPs (331), and unique cert data received from ISPs (331) and security vendors (334). Volume data may include MTA (mail server) inbound logs indicating who sent mail to the ISP and what the ISP did with it (e.g., filter it, reject it, accept it, etc.), which is sometimes referred to as “telemetry” data in Europe, as well as the number of messages sent from an IP address or domain for a specified time period. Message level data may include, for example, actual full message including header, body, URIs or any redacted part of each to remove PII. It can also include additional information such as spam trap hit, specific authentication failure, complaint rate and/or inbox placement data. Authentication data may include SPF/DKIM authentication logs, aggregate logs of all messages purporting to be from a domain with the authentication and DMARC or private policy disposition, and forensics (i.e., messages purporting to be from a domain, but that aren't properly authenticating or passing DMARC policy, such as spam/phishing messages or messages with broken forwarding or broken infrastructure). Unique certification data may include one off feeds for clients which are, for example, part of the Return Path Certification program, containing only data on certified members, used for security analysis. Data received from data feeds can also include other data not specifically mentioned herein.

Turning to block 340, the analytics model, which functions within the email monitor application 255, receives data from the seed database 257, the subscriber database 259, and the data feed database 258, and analyzes that data to provide senders with actionable recommendations for improving message deliverability and engagement at both the sender and campaign levels as described below.

Turning to FIGS. 4A and 4B, shown therein are exemplary variables that may be used by the analytics model to provide actionable recommendations. Each row of FIGS. 4A and 4B corresponds to a unique variable, while the columns include Variable Category, Variable Name, Description, and Recommendation. The information provided in FIGS. 4A and 4B is for illustrative purposes only and is not intended to limit the scope of the invention. For example, additional variables and variable categories, and associated alerts and recommendations, may be incorporated without deviating from the scope of the invention.

The exemplary variable categories shown in FIGS. 4A and 4B include ENGMT_DOMAIN, ENGMT_IP, MSG, SA_RULE, SUBJ_PROP, SUBJ_PUNC, and SUBJ_WORD. Each of those variable categories includes one or more unique variables. For each variable shown in FIGS. 4A and 4B, a description of the variable is provided, as well as an action associated with the variable that may be generated by the analytics model.

It is contemplated that the invention may involve the analysis of several types of variables. Engagement variables correspond to data received from the subscriber panel. More specifically, engagement variables provide an indication of how recipients interact with email messages (e.g., whether users read messages, delete messages without reading, complain about messages, etc.). Preferably, the values for engagement variables are determined in accordance with the methods described in U.S. patent application Ser. No. 13/538,518. Engagement variables may be associated with messages sent from one or more particular sender domains or sender IP addresses, and may be stored in the subscriber deliverability database 259.

Reputation variables are derived from a trusted cooperative network, which may include ISPs, email service providers, hosting companies, feedback loops, spam trap networks, security companies, and other companies that receive large volumes of email. Reputation variables may be used to characterize a specific sender, domain, or IP address, and may include variables such as complaint rates, unknown user rates, delivered rates, volume, spam trap hits, etc., as reported by receiving email infrastructures worldwide. Reputation variables may be stored in the data feed database 258. The values of reputation variables associated with a particular sender may be used, collectively, by the analytics model to generate the Sender Score. Similar to a credit score associated with an individual consumer, the sender score may provide an indication of the trustworthiness of an email source.

Message daemon variables, or message variables, may be used to characterize a particular message, and include overall properties of the message such as message size, whether the IP address sending the message is from an ESP or in-house system, whether the message is fingerprinted by Cloudmark, etc. Values for message daemon variables may be extracted by processing each email campaign message in accordance with the invention. For example, the processing performed by the message daemon may include extracting, analyzing, and storing message components and information. For example, the message daemon may determine the length of the message subject line in characters, store the words either in whole or in pieces (n-grams), follow links in a message to determine whether they point to final domains or whether following them results in redirection, etc. Message daemon variables may be stored in the seed database 257, or the subscriber database 259.

Spam assassin (SA) rule variables include variables related to specific message attributes that have been determined to significantly impact message inbox placement. Values for SA rule variables are determined based upon whether the message passes or fails a set of regular expressions that are configured within the system. The present invention may utilize a standard set of spam assassin rules as are known in the art, and may also incorporate custom rules based on additional message characteristics that have been determined to affect message inbox placement.

Content variables relate to components of a message such as attributes of the subject line (e.g., words, length, usage of symbols) and the overall body of the message (e.g., encoding type, use of CSS, specific word use).

For each message analyzed by the system, the analytics model processes the message to generate values for one or more of the variables. Alternatively or in combination, the analytics model retrieves values for one or more of the variables from the seed database 257, the subscriber database 259, and/or the data feed database 258. Once a value for a variable is determined, the value is compared to an ideal value or ideal range for the variable. If the value differs from the ideal value, or falls outside the ideal range, the analytics model may generate an alert and/or recommendation based on the value. Ideal values or ranges for variables may, for example, be calculated by evaluating email campaigns that are known to have a 100% (or near 100%) inbox placement rate. Those campaigns, or their senders, may be classified as best-in-class campaigns or senders. Ideal values can then be determined based on the median or average values exhibited by the best-in-class campaigns or senders.

In a preferred embodiment, values for all of the variables are received by the analytics model and analyzed to determine which of those variables, or combination of variables, are likely to be having the most negative impact on inbox placement. The analytics model orders those variables, or combinations of variables, according to their level of impact. The analytics model then generates actionable recommendations based on those variables or combinations of variables. In other words, the analytics model may rank the actionable recommendations it provides by level of importance. This feature enables senders to identify which recommendations to follow first in order to achieve the most significant improvement in inbox placement.

In one example of the present invention, the analytics model may assign a value to the variable MSG_HAS_UNSUBSCIRBE_LINK by processing the message to determine whether an unsubscribe link is present in the body of the message. If an unsubscribe link is present, the value of that variable is set to TRUE. If no unsubscribe link is present, the value of that variable is set to FALSE. If the value is FALSE, the analytics model may generate an alert to inform the sender that the message does not have an unsubscribe link present in the body of the message. The analytics model further generates a recommendation for the sender to include a 1-click unsubscribe link within the body of the message. Such a recommendation is useful because, in some instances, the absence of an unsubscribe link in a message may prevent the message from being delivered to an intended recipient's inbox. In addition, the analytics model may determine the significance that variable is having on the inbox placement rate for the associated campaign. For instance, the analytics model may determine that that variable is most likely the primary cause of low inbox placement.

In another example, the analytics model may assign a value to the variable MSG_MAX_URI_SIZE by processing the message to determine the size of each URI present in the body of the message. Several approaches for measuring URI size may be used in accordance with the present invention and different variables can be used for each. For example, URI size may be measured in total characters, as well as the number of “.” characters present in the URI to denote sub domains. The value of that variable stored for each URI present in the body of the message. If the value of any URI size variable exceeds the ideal range, then the analytics model may generate an alert to inform the sender that the size of one or more URIs within the message is too long. The alert may include a list of each URI within the message that exceeds the ideal value. The analytics model further generates a recommendation for the sender to delete or reduce the size of one or more URIs within the message. Such a recommendation is useful because, in some instances, the presence of one or more URIs of excessive length in a message may prevent the message from being delivered to an intended recipient's inbox.

In yet another example, the analytics model may assign a value to the variable SUBJ_PROP_HAS_ALL_CAPS by processing the message to determine whether the subject consists entirely of capital letters (i.e., all the letters in the subject are capitalized). The value of that variable is set to TRUE if all the letters in the subject are capitalized, and is set to FALSE otherwise. If the value is TRUE, the analytics model may generate an alert to inform the sender that the subject consists entirely of capital letters. The analytics model further generates a recommendation for the sender to change letters, such as all but the first letter in each word, to lower case. Such a recommendation is useful because, in some instances, a subject consisting of entirely capital letters in a message may prevent the message from being delivered to an intended recipient's inbox.

In yet another example, the analytics model may process the message to determine whether the subject includes one or more words or punctuation characters that have been previously identified as problematic. For example, some words and punctuation characters are highly correlated with spam folder placement. If the subject includes one or more of the problematic words or punctuation characters, the analytics model may generate one or more alerts to inform the sender that the subject contains a word or punctuation character that may be causing problems. Each alert may identify the problematic word or punctuation character. The analytics model further generates one or more recommendations for the sender to remove the problematic word or punctuation character, or to replace it with a different word or white space, for example. Such a recommendation is useful because, in some instances, the presence of one or more problematic words or punctuation characters in a message may prevent the message from being delivered to an intended recipient's inbox.

To determine words and punctuation characters that are highly correlated with spam folder placement, the present invention may perform an analysis in which it runs a random forest model, for example, on all words present in the subject lines of messages that are delivered to inboxes as well as spam folders. Preferably, that determination is made at least on a weekly basis, so that the recommendations provided by the present invention accurately reflect the current state of spam filtering.

Examples of specific words that have previously been found to be problematic when included in message subjects include, but are not limited to: $50, $500, call, claim, com, credit, daily, day, didn't, earn, enjoy, fall, find, from, gold, good, his, home, like, limited, minutes, money, new, now, off, para, plus, points, preview, ready, savings, shared, silver, skype, social, survey, tonight's, update, value, welcome, win, and you!. Examples of specific punctuation characters that have previously been found to be problematic when included in message subjects include, but are not limited to: “−”, “!”, “$”, “%”, “&”, “/”, “:”, “?”, and “+”.

In an example involving the combination or interrelation of variables, the analytics model may process the message to determine whether the sender is not using DKIM, or fails DKIM authentication, and whether the sender or the message content is being spoofed by another party with a malicious intent (e.g., phishing attack, or spoofing for spam purpose or brand fraud). The presence of both of those conditions may have a significant negative impact on inbox placement. U.S. application Ser. No. ______, titled REAL-TIME CLASSIFICATION OF EMAIL MESSAGE TRAFFIC, to the present Assignee, the contents of which are hereby incorporated by reference, describes methods for determining whether a sender is using DKIM and whether message content is being spoofed. Furthermore, ISPs may assign bad engagement metrics and other negative variables to all messages (including spoofed messages) that appear to originate from a particular sender, regardless of whether the messages were legitimately sent by the sender or malicious third parties. If the analytics model determines that both of those conditions are satisfied, the analytics model may generate an alert to inform the sender that DKIM authentication has failed and that the sender or message is being spoofed. The analytics model further generates a recommendation for the sender to begin signing with DKIM and setup a DMARC policy to differentiate its legitimate email from non-legitimate email, restore positive engagement metrics, and improve inbox placement.

In yet another example involving the combination or interrelation of variables, it may be the interrelation between values, rather than the values of the individual variables themselves, that determines the recommendations generated by the analytics model. For example, two senders might each have a complaint rate of greater than 2%. If complaint rate was the only variable that governed inbox placement, both of those senders' email campaigns might be placed in spam folders based on those senders' complaint rates. However, message type and message content may also influence inbox placement. If the analytics model determines that the content of a first sender's email campaign is a retail shipping notification, and that the content of a second sender's email campaign is an affiliate newsletter (e.g., a third party newsletter/advertisement to subscribers that signed up to receive email from the second sender), the analytics model may further determine that a complaint rate of 2% and content type of retailer shipping notification will not result in spam folder placement, but may determine that a complaint rate of 2% and content type of affiliate newsletter will result in spam folder placement and alert the second sender accordingly. The analytics model could then produce a series of recommendations for the second sender to establish a program for reducing complaints associated with email including affiliate content.

Several actionable recommendations for improving inbox placement are also beneficial in improving recipient engagement. For example, an excessive amount of words or capital letters in a message subject may negatively affect inbox placement, as well as increase the likelihood that the message will be marked as spam or deleted without being read. In such instances, the analytics model may generate a recommendation for the sender to reduce the length or number of capital letters in the message subject. It should be noted that in some cases the analytics model may determine that a particular variable, or combination of variables, is not significantly affecting inbox placement but may be having a significant negative impact on engagement. In such instances, the analytics model may alert the sender as to which variables are negatively impacting engagement and generate an appropriate recommendation for improving engagement.

In another example, the analytics model may determine that the frequency with which a sender is sending email campaigns is too high, and thus negatively affecting inbox placement. The analytics model may also determine that the high frequency is negatively affecting engagement. Such determinations may be made, for example, in a situation in which an increased sending frequency results in recipients being undesirably bombarded with a sender's email campaigns, and therefore less likely to interact with any of those campaigns. In such a situation, the analytics model will generate a recommendation for the sender to improve inbox placement and engagement by reducing the frequency with which email campaigns are sent.

In yet another example, the analytics model may determine that the frequency with which a sender is sending email campaigns is sufficiently low as to not affect inbox placement. The analytics model may also determine that an increase in that frequency could have a positive effect on engagement. Such determinations may be made, for example, in a situation in which an increased sending frequency increases recipients' awareness of a particular sender, along with those recipients' desire to interact with that sender's email campaigns. In such a situation, the analytics model will generate a recommendation for the sender to improve engagement by increasing the frequency with which email campaigns are sent.

In still another example, the analytics model may generate recommendations to improve a sender's return on investment (ROI) for an email campaign. ROI can be viewed as the total amount of money the sender can generate from a campaign (due to sales, etc.) less any costs, expenditures, or other monetary losses (due to decreased engagement, etc.) associated with the campaign. For example, the analytics model may determine that the frequency with which campaign emails are sent could be increased without negatively affecting inbox placement or engagement, and generate a recommendation to increase message frequency. If message frequency can be increased at little or no additional cost to the sender, the sender can significantly improve its ROI by following the recommendation to increase message frequency. In another example, the analytics model may determine that the time and/or day of the week at which campaign email messages are sent could be changed to increase subscriber engagement, and generate a recommendation consistent with that determination. If the sender can change its time or day for sending messages while incurring little or no additional cost, the sender can significantly improve its ROI by doing so.

Generally, recipients will only interact with email messages if those messages are first delivered to the recipients' inboxes. Therefore, in instances in which inbox placement is not at or near 100%, the recommendations generated by the analytics model will preferably be primarily directed to improving inbox placement. If it is determined that inbox placement is at or near 100%, the recommendations generated by the analytics model will be primarily directed to improving engagement.

The present invention may include memory for storing a lookup table. The lookup table may include all of the information shown in FIGS. 4A and 4B, as well as similar information corresponding to additional variables, so that upon generating or receiving a value for any given variable, or combination of variables, the analytics model may access the lookup table to perform a comparison of the value to the corresponding ideal value or ideal range, and to provide a corresponding alert and/or recommendation when appropriate.

Turning to FIGS. 5 and 6, shown therein are various screen views that may be displayed to a user, such as an email sender or campaign manager, in accordance with an exemplary embodiment the invention. The screen views shown in FIGS. 5 and 6 are provided for exemplary purposes and are not intended to limit the scope of the invention. For example, each of the screens shown therein may include a different arrangement of information, or may provide more or less information than is illustrated in FIGS. 5 and 6 without deviating from the scope of the invention.

Shown in FIG. 5 is an example of a campaign overview screen 500, a single screen that allows a user to view information related to multiple email campaigns initiated by the user. The screen 500 may include a drop-down menu 501 that allows the user to select the time period (e.g., last 7 days, last 30 days) for which campaign information is to be viewed. The screen 500 includes overall deliverability statistics 510, which indicate the overall deliverability (i.e., the percentage of messages that were delivered to inboxes, delivered to spam folders, or not delivered) for all messages sent by the user during the specified time period. An engagement benchmark icon 511, indicating recipients' overall engagement with the user's campaigns may also be displayed. Preferably, the engagement benchmark icon 511 is generated in accordance with the methods described in U.S. patent application Ser. No. 13/538,518. The overall deliverability statistics 510, which include inbox placement rates, may also indicate the overall deliverability of messages sent by all users of the system, so that the present user may compare his or her specific deliverability statistics to those of others.

The campaign overview screen 500 may include a list of priority ISPs 520, selected by the user, so that the user may view deliverability statistics associated with one or more unique ISPs, and thus compare the performance of the user's campaigns as handled by various ISPs. That feature assists users by allowing them to modify their campaigns, if necessary, to improve the deliverability of messages handled by one or more specific ISPs. The screen 500 may also include a list of user IP addresses 530, along with deliverability statistics for each of those IP addresses. In instances in which the user utilizes multiple IP addresses to send campaign messages, that feature assists users by allowing them to modify which IP addresses are used to send messages, if necessary, to improve the overall deliverability of messages.

With continued reference to FIG. 5, the campaign overview screen 500 may include a list 540 of all the campaigns initiated by the user during the specified time period. For each campaign, the list 540 may include campaign specific information including the user name, an engagement benchmark, deliverability statistics, date, subject line, unique campaign identifier, sender domain, complaints, and problems that may have affected message deliverability.

Shown in FIG. 6, is an exemplary campaign details screen 600 that a user may access by clicking on one of the individual campaigns listed on the campaign overview screen 500, for example. For the individual campaign shown on the screen 600, the screen 600 may include the campaign specific information 610 also shown on the campaign overview list 540 of FIG. 5. The screen 600 may also include a link 611 that, when clicked, allows the user to view the content of the email message associated with the campaign.

The campaign details screen 600 may include a campaign diagnostics area 620, which includes information related to problems associated with the email campaign. It is understood that such problems may include factors that negatively affect the deliverability of campaign messages. The user may select which type of diagnostic information to view by selecting one of IP reputation, infrastructure, message content, or one or more specific ISPs (e.g., Gmail).

In the campaign diagnostics area 620 shown in FIG. 6, the user has indicated that he or she wishes to view diagnostic data related to a specific ISP (i.e., Gmail). The campaign diagnostics area 620 includes a frequency of problems summary 621, which shows the problems associated with the email campaign, as determined by the analytics model, as well as how frequently those problems presented themselves across all of the IP addresses utilized by the user in connection with the campaign. That feature is beneficial because it aids users in prioritizing which specific problems to address in order to most effectively improve message deliverability.

The campaign diagnostics area 620 further includes a top problems per IP area 630 in which, for each IP address utilized by the user, the problems exhibited by messages sent via the IP address are shown. For each IP address, the top problems per IP area 630 may include the IP address, inbox placement data, and a list of problems ordered by importance. For each problem, the problem name, the value of the corresponding variable, and an action link may be displayed. By clicking an action link corresponding to one of the problems, the user may be presented with an alert informing the user of the nature of the problem, as well as an actionable recommendation that the user may implement to overcome the problem.

In addition, the present invention may further condense the list of problems into a single, more general, top problem that may be shown in the “Problems” column 550 shown in the campaign overview screen 500 of FIG. 5. That feature is advantageous over prior art systems that only show problems indicated by basic diagnostic checks for reputation, infrastructure, content, and seeding issues. Unlike the present invention, those prior art systems do not inform senders of the top problem for the sender to resolve in order to improve inbox placement and/or engagement at a specific ISP or group of ISPs.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A method for improving the inbox placement of an email campaign, the method comprising the steps of:
analyzing one or more values associated with an email message, wherein each value corresponds to an attribute of the message that may affect inbox placement of the message; and
generating an actionable recommendation for improving the inbox placement of the message based on the one or more values.

2. The method of claim 1 further comprising the step of:
prior to analyzing the one or more values, receiving at least one of the one or more values from a seed database.

3. The method of claim 1 further comprising the step of:
prior to analyzing the one or more values, receiving at least one of the one or more values from a subscriber database.

4. The method of claim 1 further comprising the step of:
prior to analyzing the one or more values, receiving at least one of the one or more values from a data feed database.

5. The method of claim 1 further comprising the steps of:
prior to analyzing the one or more values, receiving at least one of the one or more values from a seed database, receiving at least one of the one or more values from a subscriber database, and receiving at least one of the one or more values from a data feed database.

6. The method of claim 1 further comprising the step of monitoring the inbox placement of email messages sent in connection with the campaign.

7. The method of claim 6 further comprising the step of displaying inbox placement data to a user.

8. The method of claim 1 further comprising the step of displaying the actionable recommendation to a user.

9. The method of claim 1 further comprising the step of determining a message type of the email message,
wherein the actionable recommendation relates to said message type.

10. The method of claim 1 further comprising the step of determining a frequency with which a sender of the email message sends email messages,
wherein the actionable recommendation relates to changing said frequency.

11. The method of claim 1 further comprising the step of determining whether a sender of the email message sends email messages to one or more targeted groups of recipients,
wherein the actionable recommendation relates to sending email messages to one or more targeted groups of recipients.

12. The method of claim 1, wherein at least one of the one or more values relates to the presence of a word or a punctuation mark in a subject line of the email message,
wherein the word or punctuation mark has been determined to be correlated with spam folder placement, and
wherein the actionable recommendation relates to said word or punctuation mark.

13. The method of claim 12 further comprising the step of determining one or more words or punctuation marks that are correlated with spam folder placement.

14. A method for improving recipient engagement with an email campaign, the method comprising the steps of:
analyzing one or more values associated with an email message, wherein each value corresponds to an attribute of the message that may affect recipient engagement with the message; and
generating an actionable recommendation for improving recipient engagement with the message based on the one or more values.

15. The method of claim 14 further comprising the step of:
prior to analyzing the one or more values, receiving at least one of the one or more values from a seed database.

16. The method of claim 14 further comprising the step of:
prior to analyzing the one or more values, receiving at least one of the one or more values from a subscriber database.

17. The method of claim 14 further comprising the step of:
prior to analyzing the one or more values, receiving at least one of the one or more values from a data feed database.

18. The method of claim 14 further comprising the steps of:
prior to analyzing the one or more values, receiving at least one of the one or more values from a seed database, receiving at least one of the one or more values from a subscriber database, and receiving at least one of the one or more values from a data feed database.

19. The method of claim 14 further comprising the step of monitoring recipient engagement with email messages sent in connection with the campaign.

20. The method of claim 19 further comprising the step of displaying engagement data to a user.

21. The method of claim 14 further comprising the step of displaying the actionable recommendation to a user.

22. The method of claim 14 further comprising the step of determining a message type of the email message,
wherein the actionable recommendation relates to said message type.

23. The method of claim 14 further comprising the step of determining a frequency with which a sender of the email message sends email messages,
wherein the actionable recommendation relates to changing said frequency.

24. The method of claim 14 further comprising the step of determining whether a sender of the email message sends email messages to one or more targeted groups of recipients,
wherein the actionable recommendation relates to sending email messages to one or more targeted groups of recipients.

25. A system for improving the inbox placement or engagement for an email campaign, the system comprising:
a seed database configured to receive and store data related to one or more seed email accounts;
a subscriber database configured to receive and store data related to one or more subscriber email accounts;
a data feed database configured to receive and store data from one or more trusted networks; and
a processor configured to generate recommendations for improving email message inbox placement or engagement.

26. A method comprising the steps of:
analyzing email subscriber data to determine a plurality of email recipients' general level of engagement with a plurality of email campaigns or email senders;
analyzing the email subscriber data to determine the plurality of email recipients' specific level of engagement with a specific email campaign or email sender;
comparing the recipients' general level of engagement with the recipients' specific level of engagement; and
presenting a value or other metric that indicates a result of the comparison.
